(19) United States
(12) Patent Application Publication
(10) Pub. No.: US 2024/0290154 A1
(43) Pub. Date: Aug. 29, 2024

(54) ACCESS SYSTEM AND METHOD FOR OPERATING AN ACCESS SYSTEM

(71) Applicant: Harman Becker Automotive Systems GmbH, Karlsbad (DE)

(72) Inventor: Jens Scholz, Karlsbad (DE)

(21) Appl. No.: 18/590,605

(22) Filed: Feb. 28, 2024

(30) Foreign Application Priority Data
Feb. 28, 2023 (DE) 102023104917.8

(51) Int. Cl. G07C 9/22; G07C 9/00

(52) U.S. Cl. CPC G07C 9/22; G07C 9/00309; G07C 9/00896; G07C 2009/00793; G07C 2209/63

(57) ABSTRACT

An access system has a first communication unit arranged in an object and a second communication unit arranged in a key associated with the object, wherein the first communication unit is configured to broadcast a first request signal, the second communication unit is configured to receive the first request signal and, after receiving the first request signal, to send a first response signal to the first communication unit, wherein the first communication unit is further configured to send a request for a value to the second communication unit, and the second communication unit is configured to determine the value upon receipt of the request and to send the value to the first communication unit, wherein the value is an indicator of how high the probability is that the object is to be used by an authorized us.

### CROSS REFERENCE TO RELATED APPLICATIONS

The present application claims priority to German Patent Application No. 102023104917.8, entitled “ACCESS SYSTEM AND METHOD FOR OPERATING AN ACCESS SYSTEM”, and filed on Feb. 28, 2023. The entire contents of the above-listed application is hereby incorporated by reference for all purposes.

### BACKGROUND

The invention relates to an access system, in particular an access system for a vehicle, as well as a method for operating an access system.

Vehicles and other objects can frequently be unlocked without actively using a (vehicle) key. Carrying the key with you is sufficient; the key does not have to be actively actuated by the user. For example, the object broadcasts one or more request signals at regular intervals or in response to defined triggering events, which have a specific range. If the key is within said range, it receives the request signals and sends corresponding response signals back to the object. If the key is recognized as being associated with the object based on the response signals, the latter will be unlocked. However, such systems can be attacked relatively easily by so-called relay attacks. Therefore, an access system is required that is protected as effectively as possible against unwanted relay attacks by unauthorized persons.

### OVERVIEW

An access system is proposed. The access system has a first communication unit arranged in an object and a second communication unit arranged in a key associated with the object, wherein the first communication unit is configured to broadcast a first request signal, the second communication unit is configured to receive the first request signal and, after receiving the first request signal, to send a first response signal to the first communication unit, wherein the first communication unit is further configured to send a request for a value to the second communication unit, and the second communication unit is configured to determine the value upon receipt of the request and to send the value to the first communication unit, wherein the value is an indicator of how high the probability is that the object is to be used by an authorized user. The object is configured to use the first response signal to check whether the key is a key associated with the object and to compare the value received from the second communication device with a defined threshold value, wherein the object is unlocked when the key is recognized as being associated with the object and the value is greater than or equal to the threshold value.

Furthermore, a method for operating an access system for an object is proposed, comprising: broadcasting a first request signal by means of a first communication unit arranged in the object, receiving the first request signal by means of a second communication unit arranged in a key associated with the object and, after receiving the first request signal, broadcasting a first response signal to the first communication unit by the second communication unit, broadcasting a request for a value to the second communication unit by means of the first communication unit, upon receipt of the request, determining the value in the key, and sending the value to the first communication unit by means of the second communication unit, wherein the value is an indicator of how high the probability is that the object is to be used by an authorized user, checking, based on the first response signal, by the object, whether the key is a is a key associated with the object, and comparing the value received from the second communication device to a defined threshold value, wherein the object is unlocked when the key is recognized as being associated with the object and the value is greater than or equal to the threshold value.

Implementations and further developments of the inventive concept are the subject matter of sub-claims.

### BRIEF DESCRIPTION OF THE DRAWINGS

The invention is explained in more detail below with reference to the embodiments shown in the figures (FIG.), identical or similar elements being provided with the same reference symbols.

FIG. 1 schematically shows the principle of an unintentional relay attack on a keyless entry system.

FIG. 2 shows in a sequence diagram a method according to embodiments of the disclosure.

FIG. 3 shows in a sequence diagram a method according to further embodiments of the disclosure.

### DETAILED DESCRIPTION

The underlying idea of the disclosure is to use the additional query of a value (probability of use) to estimate how likely it is that an authorized user actually wants to unlock the object and not an unauthorized person. Various information can be taken into account to determine the value.

Access systems according to embodiments of the disclosure are explained in more detail below with reference to vehicle access systems. The term vehicle here includes any type of vehicle such as cars, trucks, motorcycles, tractors, airplanes, ships, etc. However, the disclosed access systems can also be used in the same or similar way for any other objects and applications (e.g., buildings, barriers, etc.).

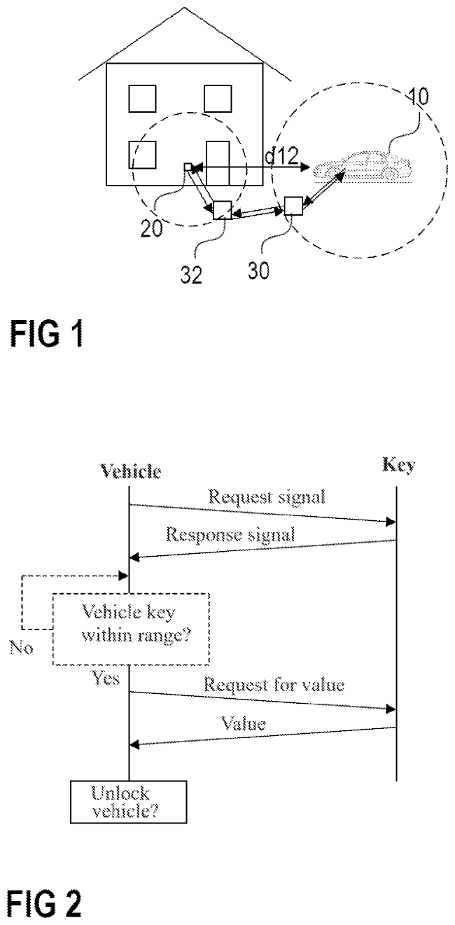

FIG. 1 schematically shows the principle of an unintentional attack on a keyless entry system. A vehicle 10 usually broadcasts one or more request signals either regularly or in response to certain triggering events. Request signals are usually electromagnetic signals, for example in the LF (Low Frequency) or HF (High Frequency) range. A triggering event may be, for instance, touching or operating a door handle. The request signals broadcast by the vehicle 10 are transmitted in encrypted form and have a defined range of several meters, for example (e.g., 10 meters). In principle, however, shorter or longer ranges are also possible. If a vehicle key 20 is within said defined range, then it receives the request signals, evaluates them, and sends corresponding response signals back to the vehicle 10. The response signals broadcast by the vehicle key 20 are also usually transmitted in encrypted form. Based on the response signals, the vehicle 10 can recognize whether it is an authorized vehicle key 20. The vehicle 10 is only unlocked if the vehicle key 20 is recognized as being associated with the vehicle 10.

However, such systems can be attacked relatively easily, as shown as an example in FIG. 1. FIG. 1 shows a typical situation where a user has parked the vehicle 10 in front of the house and left the associated vehicle key 20 in the house near the front door. The distance d12 between the vehicle 10 and the vehicle key 20 is so great that the vehicle key 20 cannot receive any request signals from the vehicle 10. In so-called relay attacks, a first device 30 is positioned around the vehicle 10 within the required range (shown in FIG. 1 with a dashed circle). The first device 30 receives the request signals from the vehicle 10 and forwards them (possibly extending the range) to a second device 32, which is located within the required range around the vehicle key 20 (shown in FIG. 1 with a dashed circle). The second device 32 in turn forwards the request signals to the vehicle key 20, which then broadcasts corresponding response signals. The response signals are again transmitted to the vehicle 10 by means of the arrangement from the first device 30 and the second device 32 (this time in the opposite direction). Since the response signals were actually broadcast by the vehicle key 20 associated with vehicle 10, they are recognized by the vehicle 10 as correct and the vehicle key 20 as associated with vehicle 10, and the vehicle 10 is then unlocked and can be opened. It may also be possible to start the vehicle 10 in the same way. This means that the vehicle can be opened and/or started by unauthorized persons even though the vehicle key 20 is not within the required range around the vehicle 10. By means of the arrangement of the first device 30 and the second device 32, distances of up to several hundred meters can be bridged if the signals are amplified accordingly.

The vehicle key 20 may be a dedicated vehicle key. Nowadays, however, mobile phones are increasingly taking over the functionality of vehicle keys. This means that the vehicle key 20 can be a mobile phone (smartphone) with a corresponding application (app) installed on it. According to embodiments of the disclosure, in addition to the normal request signal from the vehicle 10, a request for a value is sent to the vehicle key 20, wherein the requested value is an indicator of the likelihood that the vehicle 10 is actually to be used by an authorized user. Based on this value, which the vehicle key 20 determines in response to the request and transmits to the vehicle 10, the vehicle 10 then decides whether the desired action (unlocking, starting) will actually be carried out. This means that a decision is made not only based on the receipt of a correct response signal, but also on the level of a usage probability (based on the value determined). For example, the vehicle 10 can be unlocked if a correct response signal has been received and the requested value also corresponds to or exceeds a predefined threshold value. This threshold value can be set by the car manufacturer, for example. In principle, however, it is also possible for a user to set this threshold value individually for their needs.

The vehicle 10 can send the request for the value (the probability of use) directly in the request signal. This means that only a signal to which the vehicle key 20 responds with a response signal can be broadcast from the vehicle 10. The requested value can be transmitted within the response signal. However, the vehicle 10 can also broadcast two separate request signals. The vehicle key 20 can also transmit the desired value in the response signal or send two separate signals to the vehicle 10.

According to one embodiment of the disclosure, a request for the value to the vehicle key 20 is only broadcast by the vehicle 10 once a correct response signal has been received by the vehicle key 20. This is shown as an example in the sequence diagram in FIG. 2. The request for the value (hereinafter also referred to as the second request signal) can be transmitted via the same or via a different connection as the first request signal. For example, contrary to the first request signal, the second request signal can be transmitted to the vehicle key 20 via a Bluetooth or Bluetooth Low Energy (BLE) connection. However, other secure transmission channels are also possible.

The vehicle 10 can broadcast the second request signal directly after receiving the first response signal, for example. Alternatively, however, it is also possible for the vehicle 10 to wait after receiving the first response signal before broadcasting the second request signal until it is recognized that the vehicle key 20 is within a defined range around the vehicle 10 (shown in dashed lines in FIG. 2). For example, the position of the vehicle key 20 and/or its distance from the vehicle 10 can be tracked by the vehicle 10. After receiving the second request signal, the vehicle key 20 determines the value (probability of use by an authorized user) and sends it back to the vehicle 10. The vehicle 10 compares the value received from the vehicle key 20 with a defined threshold value. If the value is greater than or equal to the threshold value, the vehicle 10 is unlocked. If the value is smaller than the threshold value, the vehicle 10 remains locked.

The value indicates the probability that one of at least one authorized user would like to use the vehicle 10. If said probability is too low (value less than the threshold value), this conversely means that there is a high probability that an unauthorized user wants to use the vehicle 10. The value can be determined taking into account a variety of different factors. Each of the plurality of different factors can in turn be determined in different ways, for example by means of one or more sensors in the vehicle key 20, by means of one or more devices (peripherals) connected to the vehicle key 20 and/or on the basis of learned usage behavior of the authorized user(s). For example, the vehicle key 20 (e.g., mobile phone) can determine one or more of the following characteristics:
whether it is currently being charged,
whether it is currently moving (general movement or directed movement),
whether it is connected to a known Wi-Fi (e.g., home Wi-Fi, Wi-Fi at work, etc.),
whether the Wi-Fi connections currently available to the vehicle key 20 at least partially match the Wi-Fi connections that are also available for the vehicle 10 (for this purpose, the vehicle 10 may for example transmit corresponding information within the second request signal to the vehicle key 20),
whether the vehicle key 20 detects at least in part the same external devices (e.g., available Bluetooth devices) in its proximity as the vehicle 10 (for this purpose, the vehicle 10 may for example transmit corresponding information within the second request signal to the vehicle key 20),
whether the position determined for the vehicle key 20 is located in the proximity of the position determined for the vehicle 10 (for this purpose, the vehicle 10 may for example transmit its current position within the second request signal),
whether it is a time at which one of the one or several authorized users typically uses the vehicle 10,
whether a distance determined by the vehicle key 20 between vehicle 10 and vehicle key 20 matches a distance determined by the vehicle 10 between vehicle 10 and vehicle key 20 (for this purpose, the vehicle 10 may for example transmit the distance determined by it between the vehicle 10 and the vehicle key 20 within the second request signal),
how long it has been since the last interaction between vehicle 10 and vehicle key 20, and/or
whether a movement profile of the vehicle key 20 matches a change of position of the vehicle key 20 determined by the vehicle 10.

This means that a current situation of the vehicle key 20 is evaluated. The more different factors are taken into account when determining the value, the more accurate and reliable the system usually is. It can often be an indication of unauthorized use if the vehicle key (the mobile phone) is currently being charged and is connected to the home Wi-Fi. However, it is quite conceivable that the mobile phone is charged using a so-called power bank (portable charger), for example, and the mobile phone is still connected to the home Wi-Fi in the garage or directly in front of the house. In such a case, false negative results (unauthorized usage attempt is falsely detected) could be excluded more reliably if, for example, it is additionally detected that the usage attempt takes place in the morning, at a time when the authorized user typically leaves the house, that the vehicle 10 is also within range of the home Wi-Fi, and that the specific positions of the vehicle 10 and the vehicle key match.

The above features used to determine value are merely examples. Additionally or alternatively, any other suitable features may also be taken into account when determining the value. Different features can be weighted equally or differently.

The value may be determined merely once or multiple times. One or more of the features considered to determine the value may be changeable. For example, a connection to a Wi-Fi can be lost if a user moves towards the vehicle 10 with a vehicle key 20. This also changes the position of the vehicle key 20. The vehicle key 20 can then also take into account a change in certain features when determining the value, for example. If the position of the vehicle key 20 remains unchanged, for example, this may indicate that it is not being used by an authorized user. In such a case, the vehicle key 20 could send a further, updated value to the vehicle 10.

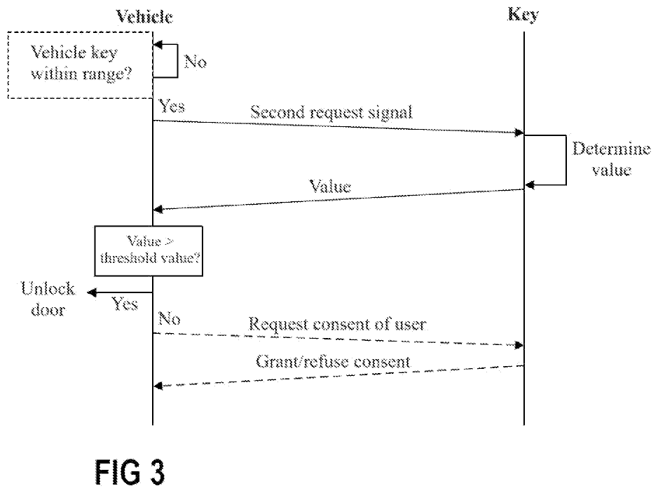

According to the method described in FIG. 2, the vehicle 10 is unlocked when the value is greater than or equal to the threshold value, and the vehicle 10 remains locked when the value is less than the threshold value. However, as shown as an example in FIG. 3, it is alternatively also possible for the vehicle 10 to request the user's consent if the value is less than the threshold value. FIG. 3 only shows an exemplary sequence from the broadcast of the second request signal. The preceding steps not explicitly shown in FIG. 3 are essentially identical to the steps already described in FIG. 2 with respect to the first request signal and the first response signal.

The vehicle 10 can therefore request explicit consent from the user if the value is less than the threshold value. For example, the user could be shown a pop-up window on their smartphone screen asking them to confirm that they want to use vehicle 10. The user can then, by selecting a corresponding button, expressly agree to the use or reject it. If the user agrees, the vehicle key 20 sends a corresponding response to the vehicle 10 and it is unlocked. If the user does not agree, either no response is sent to the vehicle 10 or unlocking of the vehicle 10 is explicitly rejected. In both cases, the vehicle 10 remains locked.

User actions that require the user to press a switch or button are generally not desired in hands-free applications in order to increase user convenience. In the method described in FIG. 3, this is accepted for cases where the determined value is below the threshold value. This allows false negative results, where the vehicle 10 would remain locked even though it is being used by an authorized user, to be overruled. It would be much more inconvenient for an authorized user if the vehicle 10 remained completely locked in the event of a false negative result. However, the more precisely the value is determined, the rarer false negative results are, so that active user consent is only requested in a few cases and user convenience remains high.

The access system described is very flexible, as it can adapt to different, changing situations by determining the value using several features. By taking a large number of different features into account when determining the value, it is also significantly more accurate and therefore more reliable than other methods that only take into account one of the features (e.g., movement pattern of the vehicle key 20).

To transmit and receive the corresponding signals, the vehicle 10 (object) can have a first communication unit (e.g., transceiver unit), and the key 20 can have a second communication unit (e.g., transceiver unit). An access system pursuant to embodiments of the disclosure has a first communication unit arranged in an object 10 and a second communication unit arranged in a key 20 associated with the object 10, wherein the first communication unit is configured to broadcast a first request signal, the second communication unit is configured to receive the first request signal and, after receiving the first request signal, to send a first response signal to the first communication unit, wherein the first communication unit is further configured to send a request for a value to the second communication unit, and the second communication unit is configured to determine the value upon receipt of the request and to send the value to the first communication unit, wherein the value is an indicator of how high the probability is that the object 10 is to be used by an authorized user. The object 10 is configured to use the first response signal to check whether the key 20 is a key associated with the object 10 and to compare the value received from the second communication device with a defined threshold value, wherein the object 10 is unlocked when the key 20 is recognized as being associated with the object 10 and the value is greater than or equal to the threshold value.

1. An access system having a first communication unit arranged in an object and a second communication unit arranged in a key associated with the object, wherein:
the first communication unit is configured to broadcast a first request signal,
the second communication unit is configured to receive the first request signal and to send a first response signal to the first communication unit after receiving the first request signal,
the first communication unit is further configured to send a request for a value to the second communication unit,
the second communication unit is configured to determine the value upon receipt of the request and send it to the first communication unit, wherein the value is an indicator of how high the probability is that the object is to be used by an authorized user,
the object is configured to use the first response signal to check whether the key is a key associated with the object, and
the object is further configured to compare the value received from the second communication device with a defined threshold value, wherein
the object is unlocked when the key is recognized as being associated with the object and the value is greater than or equal to the threshold value.

2. The access system according to claim 1, wherein the first communication unit is configured to send the request for the value to the second communication unit when the key is recognized as being within a required range around the object.

3. The access system according to claim 1, wherein the first communication unit is further configured to send a third request signal to the second communication unit when the value is less than the threshold, wherein the third request signal contains a request for a user's consent.

4. The access system according to claim 3, wherein the second communication unit is further configured to send a third response signal to the first communication unit after receiving the third request signal, wherein the third response signal contains information about a decision by the user as to whether the object is to be unlocked, wherein the object is unlocked when the third response signal contains information that the user agrees to unlocking.

5. The access system according to claim 1, wherein the key is a mobile phone with an application installed thereon, by means of which the mobile phone can act as a key for the object.

6. The access system according to claim 5, wherein the mobile phone determines the value taking into account a plurality of different factors.

7. The access system according to claim 6, wherein the plurality of different factors comprises one or more of the following:
information about whether the mobile phone is being charged,
whether the mobile phone is moving,
whether the mobile phone is connected to a known Wi-Fi,
whether the Wi-Fi connections available to the mobile phone match at least in part with the Wi-Fi connections that are available for the object as well,
whether the mobile phone at least partially detects the same external devices in its proximity as the object,
whether a position intended for the mobile phone is in the proximity of a position intended for the object,
whether the request for the value occurs at a time when one of one or more authorized users typically uses or enters the object,
whether a distance determined by the mobile phone between the object and the mobile phone matches a certain distance between the object and the mobile phone determined by the object,
how long ago a directly preceding interaction between object and mobile phone occurred, and/or
whether a movement profile of the mobile phone matches a position change of the mobile phone determined by the object.

8. The access system according to claim 1, wherein the object is a vehicle, a building, or a barrier.

9. A method for operating an access system for an object, the method comprising:
broadcasting a first request signal by means of a first communication unit arranged in the object,
receiving the first request signal by means of a second communication unit arranged in a key associated with the object and, after receiving the first request signal, broadcasting a first response signal to the first communication unit by the second communication unit,
broadcasting a request for a value to the second communication unit by means of the first communication unit,
upon receipt of the request, determining the value in the key, and sending the value to the first communication unit by means of the second communication unit, wherein the value is an indicator of how high the probability is that the object is to be used by an authorized user,
checking, using the first response signal, by the object, whether the key is a key associated with the object, and
comparing the value received from the second communication device with a defined threshold value by the object, wherein
the object is unlocked when the key is recognized as being associated with the object and the value is greater than or equal to the threshold value.
